(19) United States
(12) Patent Application Publication
(10) Pub. No.: US 2002/0118881 A1
(43) Pub. Date: Aug. 29, 2002

(54) Line based image matching method

(75) Inventors: Yang-Lim Choi, Gyeorggi-do (KR); Ki-Won Yoo, Seoul (KR); Nam-Ik Cho, Seoul (KR); Jong-Ha Lee, Seoul (KR)

Correspondence Address: SUGHRUE, MION, ZINN,, MACPEAK & SEAS, PLLC, 2100 Pennsylvania Avenue, NW, Washington, DC, 20037-3213, US

(73) Assignee: SAMSUNG ELECTRONICS CO., LTD.

(21) Appl. No.: 09/884,079

(22) Filed: Jun. 20, 2001

(30) Foreign Application Priority Data
Dec. 27, 2000 (KR) 2000-82756

(51) Int. Cl. G06K 9/46

(52) U.S. Cl. 382/203; 382/305; 707/6

(57) ABSTRACT

A line based image matching method in which a model image indexed by similar shape descriptors to a query image is retrieved from an image database indexed by line based shape descriptors. The line based image matching method involves: collecting line information of a query image and model images; defining the binary relation between the lines of the query image and the lines of the model images; measuring the compatibility coefficients of the node-label pairs of the query and model images based on the binary relation; and measuring the similarity between the query and model images on the basis of continuous relaxation labeling using the compatibility coefficient.

### BACKGROUND OF THE INVENTION

1. Field of the Invention

The present invention relates to an image matching method, and more particularly, to a line based image matching method for retrieving a model image indexed by similar shape describers to a query image from an image database indexed by line based shape describers. The present application is based on Korean Patent Application No. 2000-82756, filed Dec. 27, 2000, which is incorporated herein by reference.

A shape descriptor, as a basic image pattern recognition describer, is based on an automatically extractable lower abstraction level description. Recent approaches have been made on algorithms for describing the shape of a particular object from an image, and measuring a degree of matching accuracy or similarity based on the shape descriptors. These algorithms are sufficient to describe the shape of a particular object but not to recognize the shape of an arbitrary object. The shape descriptors suggested by the MPEG-7 standard are obtained with feature points found through a variety of modifications of a given object. There are many kinds of shape descriptors. The eXperiment Model 1 (XM) of the MPEG-7 standard suggest two types of shape descriptors: a Zemike moment shape descriptor and a Curvature scale space shape descriptor. As for the Zemike moment shape descriptor, Zemike base functions are defined for a variety of shapes of an object to investigate the distribution of the shapes within an image. Then, the image in a predetermined size is projected over all the base functions, and the resultant values are used as the shape describers. As for the curvature scale space shape descriptor, the contour of a model image is extracted, and changes of curvature points of an image along the contour are expressed as peak values on a scaled space. Then, the location of the peak values are expressed as a 2-dimensional vector. The extraction of the former shape descriptor can be applied only when each shape of the image and the base function have a similar scale. Also, the size of input image is restricted. On the other hand, a drawback of the latter shape descriptor extraction lies in that the shapes are extracted from only a single object.

According to a conventional shape descriptor based image matching method, accurate extraction of an object from a query image is needed prior to retrieving of a model image indexed by similar shape describers to the query image from a database. In other words, if the object cannot be accurately extracted, retrieving of a model image for the conventional image matching is impossible.

Therefore, there is a need for a simple image matching method capable of retrieving a model image indexed by similar shape describers to a query image from an image database indexed by line based shape descriptors, without need for accurate object extraction.

### SUMMARY OF THE INVENTION

It is an object of the present invention to provide a line based image matching method capable of retrieving a model image indexed by similar shape descriptors to a query image from a model image database indexed by line based shape describers, without need for accurate object extraction.

The object of the present invention is achieved by a line based image matching method comprising: collecting line information of a query image and model images; defining the binary relation between the lines of the query image and the lines of the model images; measuring the compatibility coefficients of the node-label pairs of the query and model images based on the binary relation; and measuring the similarity between the query and model images on the basis of continuous relaxation labeling using the compatibility coefficient.

It is preferable that the line information of each of the query and model images is expressed by shape descriptors.

It is preferable that the model images are retrieved from a database indexed by shape descriptors determined by: extracting the skeleton of a model image; thinning the skeleton; concatenating corresponding pixels based on the extracted skeleton to obtain a set of lines; and normalizing the set of lines to determine the normalized set of lines as the shape descriptors.

It is preferable that the binary relation is invariant with respect to rotations, scale changes and translations. In this case, the binary relation may include at least one of an angular difference between two lines, a ratio of the lengths, a relative location, and a relative distance.

It is preferable that measuring the compatibility coefficients of the node-label pairs based on the binary relation comprises: measuring the binary relation, denoted by ξᵢⱼ, for two nodes i and j within the set of lines of the query image; measuring the binary relation, denoted by ξ_{λλ′}, for two labels λ and λ′ within the set of lines for each of the model images; and measuring the compatibility coefficients, denoted by rᵢⱼ(λ, λ′), for the node-label pairs of the query and each of the model images. The compatibility coefficients rᵢⱼ(λ, λ′) as a measure of the strength of compatibility between the node-label pairs may have high values corresponding to compatibility and low values corresponding to incompatibility. The compatibility coefficients rᵢⱼ(λ, λ′) may be determined as 1 if the binary relation of a node pair (i, j) of the query image coincides with the binary relation of a label pair (λ, λ′). The compatibility coefficients rᵢⱼ(λ, λ′) can be expressed as:

$${r}_{ij} ( λ , {λ}^{′} ) = \frac{1}{1 + ‖ ρ ( i , j , λ , {λ}^{′} ) ‖}$$

where

$$ρ ( i , j , λ , {λ}^{′} ) = {( {\sum }_{k = 1}^{K} {‖ {ξ}_{ij}^{( k )} {ξ}_{{λλ}^{′}}^{( k )} ‖}^{α} )}^{1 / α}$$

“K” denotes the number of elements of a character vector for a defined binary relation; and “ρ” is a measure of the difference in compatibility on between node-label pairs.

It is preferable that, before measuring the similarity on the basis of the continuous relaxation labeling, the line based image matching method further comprises assigning a uniform initial probability to a predetermined number of upper node-label pairs in which the sums of the highest degree of support by each adjacent label for the nodes are within the range of an upper level, the initial probability being close to the final probability. After assigning the uniform initial probability to the upper node-label pairs, the line based image matching method may further comprise defining a probability update element for the continuous relaxation labeling as:

$${q}_{i}^{( k )} ( λ ) = {\sum }_{j} {α}_{i} ( {\sum }_{λ} {r}_{ij} ( λ , {λ}^{′} ) {p}_{j}^{( k )} ( {λ}^{′} ) )$$

where pⱼ^{(k)}(λ′) denotes the node-to-label correspondence probability, and k denotes the number of iterations needed. After defining the probability update element, the line based image matching method may further comprise updating the probability on the basis of the Zucker's theory using

$${p}_{i}^{( k + 1 )} ( λ ) = {p}_{i}^{( k )} ( λ ) + {p}_{i}^{( k )} ( λ ) \frac{{q}_{i}^{( k )} ( λ ) - \overline{{q}_{i}^{( k )}}}{{q}_{i}^{( k )}}$$

where

$${q}_{i}^{( k )} = {\sum }_{j} α {\sum }_{λ} {r}_{ij}^{( k )} ( λ , {λ}^{′} ) {p}_{j}^{( k )} ( {λ}^{′} ) , and \overline{{q}_{i}^{( k )}} = {\sum }_{λ} {p}_{i}^{( k )} ( λ ) {q}_{i}^{( k )} ( λ ) .$$

It is preferable that measuring the similarity between the query and model images comprises: calculating the sum of the distances between corresponding node-to-label pairs of the sets of lines for the query and each of the model images; and determining the reciprocal of the sum of the distances as the similarity between corresponding two images. The distances may be measured using the Euclidean distance or the Housdorff distance.

### BRIEF DESCRIPTION OF THE DRAWINGS

The above object and advantages of the present invention will become more apparent by describing in detail preferred embodiments thereof with reference to the attached drawings in which:

FIG. 1 is a flowchart illustrating the main steps of a line based image matching method according to a preferred embodiment of the present invention;

FIG. 2A illustrates a difference in slope of two lines as an example of the binary relation between two lines;

FIG. 2B illustrates an angle between the line segment connecting the middle points of two lines, and one of the two lines, as another example of the binary relation between two lines;

FIG. 3A shows an example of a query image;

FIG. 3B illustrates the query image of FIG. 3A after a line approximation of the present invention;

FIG. 3C illustrates some lines selected from the query image of FIG. 3B by a user;

FIG. 4A illustrates an example of a model image corresponding to the query image which was retrieved in a simulation test;

FIG. 4B illustrates the model image of FIG. 4A after a line approximation process;

FIG. 5A illustrates another example of a model image; and

FIG. 5B illustrates the model image of FIG. 5A after a line approximation process.

### DETAILED DESCRIPTION OF THE INVENTION

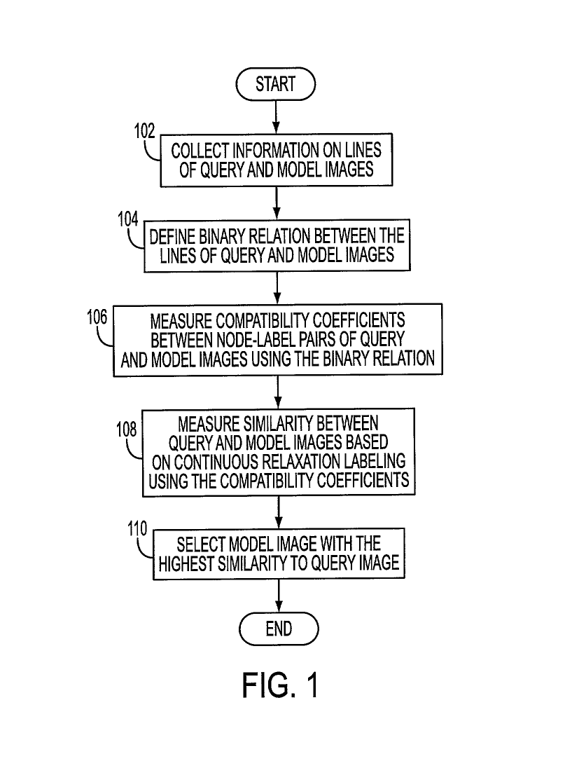

A preferred embodiment of a line based image matching method according to the present invention is illustrated in FIG. 1. Referring to FIG. 1, line information on a query image and model images are collected (step 102). Here, it is assumed that the model images are stored in a database, and indexed by line based shape descriptors. These line based shape descriptors can be extracted by the shape descriptor extraction method which has been filed on Oct. 21, 2000, by the present applicant and assigned Korean Patent Application No. 00-62163, and is incorporated herein by reference. Shape describers can be extracted from a query image by the shape descriptor extraction method. The shape descriptors extracted by the shape descriptor extraction method includes a set of lines. Line information on the query image and model images can be collected from the set of lines.

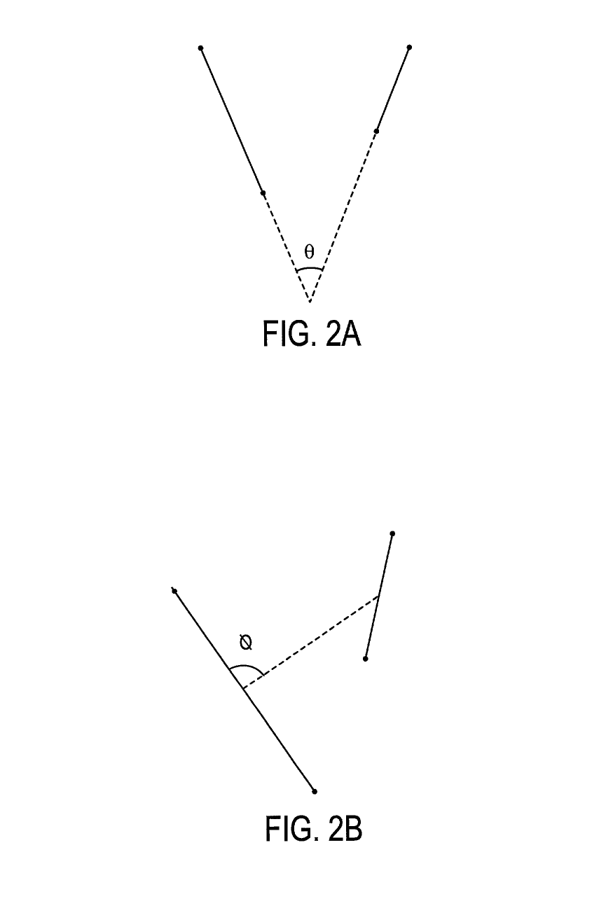

Binary relations between the lines of the query image and model images are defined (step 104). The intrinsic attributes of a single line, such as slope, length or location of the middle point, and binary relations between two lines, such as angular difference, ratio of the lengths, relative location, or relative distance between two lines, can be used as the features of the lines. In the present embodiment, the binary relations that are invariant to rotations, scale changes, and translations are used as the lines features. FIG. 2A illustrates a difference in slope between two lines as an example of the binary relation. As shown in FIG. 2A, the relative position of the two lines can be expressed by the difference (θ) in the slopes of the two lines. FIG. 2B illustrates an angle between the line segment connecting the middle points of the two lines, and one of the two lines, as another example of the binary relation between two lines. As shown in FIG. 2B, the relative location between two lines can be expressed by the angle (φ). Although not illustrated in the drawings, a ratio (r) of lengths between two lines can be used as a binary relation between the two lines.

In the line based image matching method according to the present invention, the correspondence between a set of lines for the query image, and a set of lines for the model images, are determined based on continuous relaxation labeling. For the continuous relaxation labeling, the initial probability is updated on the basis of compatibility coefficients, and a more recent labeling status. Once the initial probability is assumed, the probability is updated depending on the compatibility coefficients. The compatibility coefficients are used in modeling possible matching conditions to reach a satisfactory labeling. Accurate labeling close to a real query image is important.

Next, in step 106, the compatibility coefficients between node-label pairs of the query and model images are determined based on the binary relations defined in step 104. The procedures of step 106 are as follows. First, a binary relation value ξᵢⱼ between two nodes νᵢ and νⱼ within the set of lines for the query image is calculated based on their binary relations. Here, i and j denote the identifiers of the nodes of the query image, and are not identical to each other. A binary relation value ξ_{λλ}, between two labels λ and λ′ within the set of lines for each model image is calculated based on their binary relations. Here, λ and λ′ denote the identifiers of the labels of the model image. The strength of compatibility between the node pairs of the query image and the label pairs of the model image is expressed as the compatibility coefficient rᵢⱼ(λ, λ′). The compatibility coefficient rᵢⱼ(λ, λ′) is determined to be between 0 and 1 based on the binary relations of the query image and model images. The compatibility coefficient rᵢⱼ(λ, λ′) measures the strength of compatibility between node-label pairs: high values correspond to compatibility and low values correspond to incompatibility. For example, in considering the compatibility of the node-label pair (νᵢ, λ), if the compatibility of label λ₁ for the node νᵢ is higher than that of label λ₂, the compatibility coefficient is defined to satisfy the following relation:

rᵢⱼ(λ₁,λ′)>rᵢⱼ(λ₂λ′) (1)

When the binary relation of a node pair (i, j) of the query image coincides with the binary relation of a label pair (λ, λ′), the coefficient rᵢⱼ(λ, λ′) is determined as 1. In the present embodiment, the compatibility coefficient rᵢⱼ(λ, λ′) is expressed as

$${r}_{ij} ( λ , {λ}^{′} ) = \frac{1}{1 + ‖ ρ ( i , j , λ , {λ}^{′} ) ‖} \qquad ( 2 )$$

where

$$ρ ( i , j , λ , {λ}^{′} ) = {( {\sum }_{k = 1}^{K} {‖ {ξ}_{ij}^{( k )} {ξ}_{{λλ}^{′}}^{( k )} ‖}^{α} )}^{1 / α} ,$$

and “K” denotes the number of elements of a character vector for a defined binary relation. In formula (2), “ρ” is a measure of the difference in compatibility between node-label pairs.

Next, the similarity is determined based on the continuous relaxation labeling with the compatibility coefficients (step 108). As previously described, in a continuous relaxation labeling process, the initial probability is updated on the basis of compatibility coefficients, and a more recent labeling status. Once the initial probability is assumed, the probability is updated depending on the compatibility coefficients. The compatibility coefficients are used in modeling possible matching conditions to reach a satisfactory labeling. Accurate labeling close to a real query image is important. Step 108, performed based on the continuous relaxation labeling using the compatibility coefficients, involves a probability updating step, a normalization step, and a similarity determination step. First, a uniform initial probability is assigned to a predetermined number of upper node-label pairs in which the sums of the highest degree of support by each adjacent label for the nodes are within the range of an upper level, wherein the initial probability must be close to the final probability.

A probability update element for the continuous relaxation labeling is defined as

$${q}_{i}^{( k )} ( λ ) = {\sum }_{j} {α}_{i} ( {\sum }_{λ} {r}_{ij} ( λ , {λ}^{′} ) {p}_{j}^{( k )} ( {λ}^{′} ) )$$

where pⱼ^{(k)}(λ′) denotes the node-to-label correspondence probability, and k denotes the number of iterations needed. The probability is updated as follows on the basis of the Zucker's theory which ensures efficient convergence result:

$${p}_{i}^{( k + 1 )} ( λ ) = {p}_{i}^{( k )} ( λ ) + {p}_{i}^{( k )} ( λ ) \frac{{q}_{i}^{( k )} ( λ ) - \overline{{q}_{i}^{( k )}}}{{q}_{i}^{( k )}}$$

where

$${q}_{i}^{( k )} = {\sum }_{j} α {\sum }_{λ} {r}_{ij}^{( k )} ( λ , {λ}^{′} ) {p}_{j}^{( k )} ( {λ}^{′} ) , and \overline{{q}_{i}^{( k )}} = {\sum }_{λ} {p}_{i}^{( k )} ( λ ) {q}_{i}^{( k )} ( λ ) . \qquad ( 3 )$$

The range of each element of the character vector does not coincide with other elements, and thus there is a need for normalization. Information on lines to be matched with a query image can be clearly obtained by the node-to-label correspondence based on the relaxation labeling. One of the lines from the set for the query image is selected, and the remainder of the lines is normalized with respect to the selected line in terms of size and location. In particular, an arbitrary line is selected from the set of lines for a query image. The length of the selected line is assigned 1, and a spatial transform function is defined such that the selected line is aligned on the X-axis of an orthogonal coordinates system. Then, all the lines for the query image is transformed by the spatial transform function. This spatial transformation is carried out for all the lines of the model images corresponding to the selected lines.

Then, the similarity between the query image and model images are determined. In the present embodiment, the similarity is determined by calculating the sum of the node-to-label distances of the query and each of the model images. A variety of techniques can be applied to determine the similarity. For example, if the node-to-label correspondence between the query image and the model images is apparent, and if the normalization with respect to rotations and scale changes is carried out for the corresponding lines, the distances between the nodes and labels can be directly measured using the Euclidian distance. Alternatively, the distances can be measured using the Housdorff distance, which ensures a more accurate similarity result. In the present embodiment, the similarity between the query image and a model image is measured as follows. The distances between the corresponding nodes and labels are measured for the two line sets of the query image and each of the model images, using the Euclidian distance. Then, the sum of all the distances is calculated, and then the similarity between two images is determined with the reciprocal of the sum. A model image having the highest degree of similarity is retrieved (step 110).

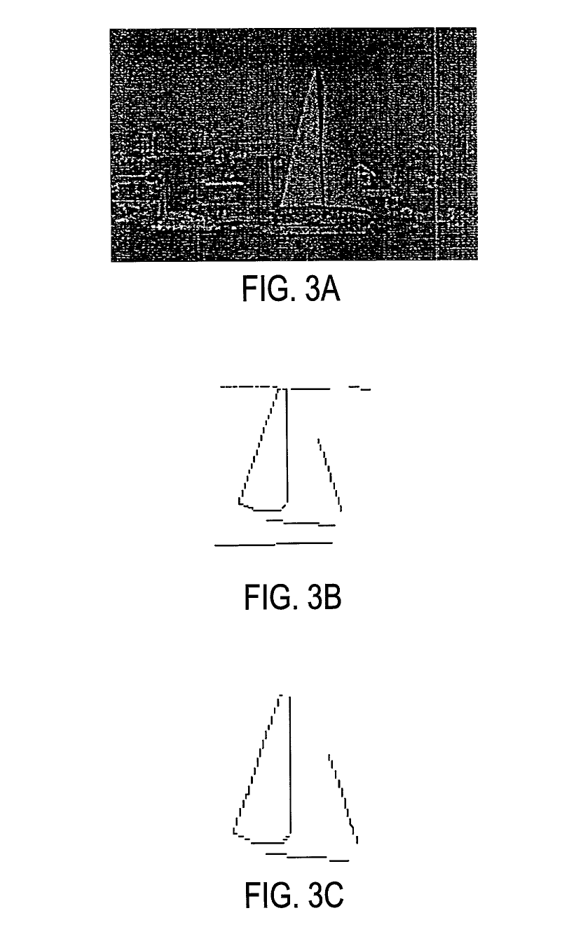

A simulation experiment was carried out based on the above-mentioned line based image matching method. Edges of a query image were extracted, and the extracted edges were approximated into lines to express the query image with the lines. Then, some of the lines of the query image were selected by a user, and then matched with model images using information on the selected lines. An example of a query image is shown in FIG. 3A. FIG. 3B illustrates the query image of FIG. 3A after the above-mentioned line approximation. FIG. 3C illustrates some lines selected from the query image of FIG. 3B by user.

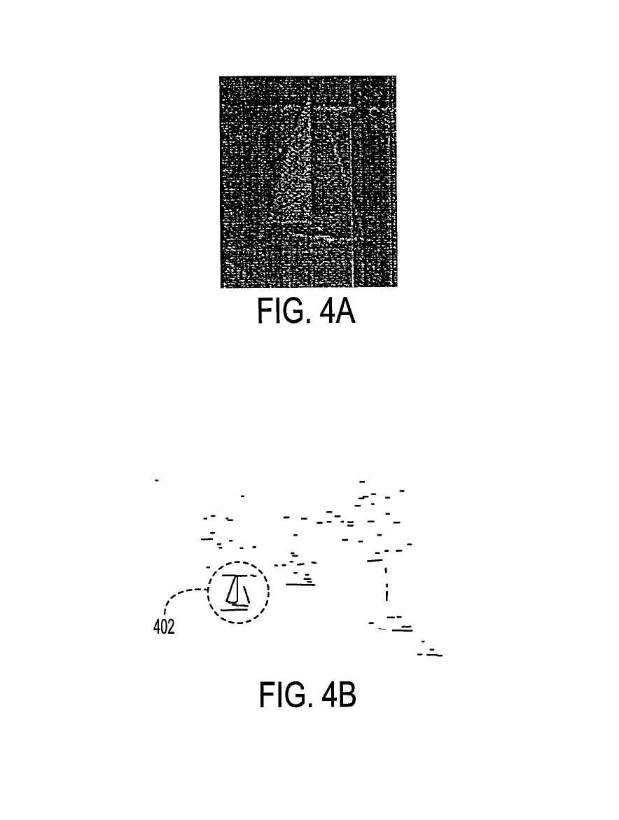

FIG. 4A illustrates an example of a model image corresponding to the query image which was retrieved in the simulation test. FIG. 4B illustrates the model image of FIG. 4A after line approximation. As shown in FIG. 4B, the retrieved model image approximated with lines, as indicated by reference numeral 402, includes similar lines to the line approximated query image, as shown in FIG. 3C.

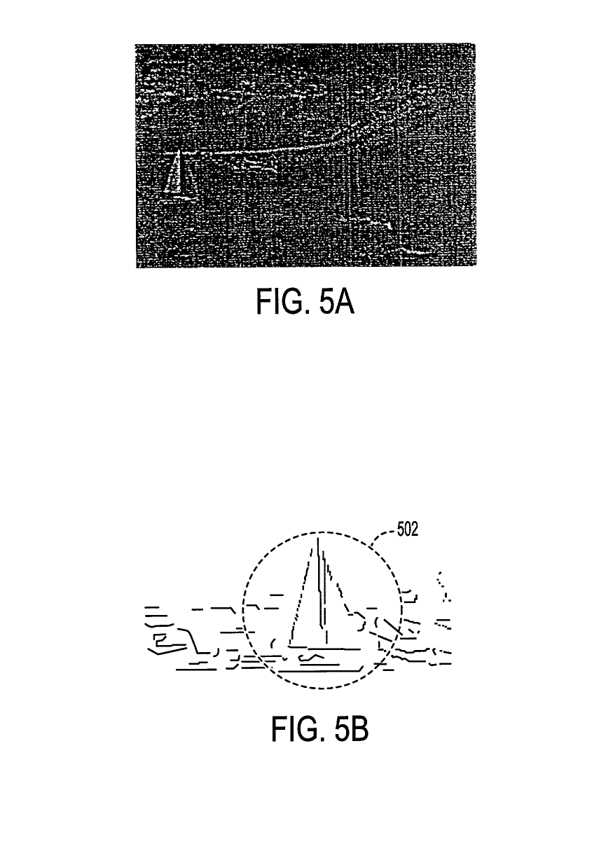

FIG. 5A illustrates another example of a model image, and FIG. 5B illustrates the model image of FIG. 5A after line approximation. As shown in FIG. 5B, the line approximated model image, as indicated by reference numeral 502, also includes similar lines to the line approximated query image, as shown in FIG. 3C.

As previously mentioned, in the line based image matching method according to the present invention, a model image with similar shape descriptors to a query image can be retrieved from an image database indexed by line based shape descriptors, without need for object extraction from the query image.

The line based image matching method according to the present invention may be embodied as a program executable on a personal or server computer. A functional program, code and code segments, used to implement the present invention, can be derived by a skilled computer programmer from the description of the invention contained herein. The program can be stored in a computer usable medium, including but not limited to storage media such as magnetic storage media, optically readable media, and carrier waves.

What is claimed is:

1. A line based image matching method comprising:
collecting line information of a query image and model images;
defining a binary relation between lines of the query image and lines of the model images;
measuring compatibility coefficients of node-label pairs of the query and model images based on the binary relation; and
measuring the similarity between the query and model images on the basis of continuous relaxation labeling using the compatibility coefficients.

2. The line based image matching method of claim 1, wherein the line information of each of the query and model images is expressed by shape descriptors.

3. The line based image matching method of claim 1, wherein the model images are retrieved from a database indexed by shape descriptors determined by:
extracting the skeleton of a model image;
thinning the skeleton;
concatenating corresponding pixels based on the extracted skeleton to obtain a set of lines; and
normalizing the set of lines to determine the normalized set of lines as the shape descriptors.

4. The line based image matching method of claim 1, wherein the binary relation is invariant with respect to rotations, scale changes and translations.

5. The line based image matching method of claim 4, wherein the binary relation includes at least one of an angular difference between two lines, a ratio of the lengths of the two lines, a relative location of the two lines, and a relative distance between the two lines.

6. The line based image matching method of claim 1, wherein measuring the compatibility coefficients of the node-label pairs based on the binary relation comprises:
measuring the binary relation, denoted by ξᵢⱼ, for two nodes i and j within the set of lines of the query image;
measuring the binary relation, denoted by ξ_{λλ′}, for two labels λ and λ′ within the set of lines for each of the model images; and
measuring the compatibility coefficients, denoted by rᵢⱼ(λ, λ′), for the node-label pairs of the query and each of the model images.

7. The line based image matching method of claim 6, wherein the compatibility coefficients rᵢⱼ(λ, λ′) as a measure of the strength of compatibility between the node-label pairs have high values corresponding to compatibility and low values corresponding to incompatibility.

8. The line based image matching method of claim 6, wherein the compatibility coefficients rᵢⱼ(λ, λ′) are determined as 1 if the binary relation of a node pair (i, j) of the query image coincides with the binary relation of a label pair (λ, λ′).

9. The line based image matching method of claim 6, wherein the compatibility coefficients rᵢⱼ(λ, λ′) are expressed as:
$${r}_{i j} ( λ , {λ}^{′} ) = \frac{1}{1 + \vert \vert ρ ( i , j , λ , {λ}^{′} ) \vert \vert}$$
where
$$ρ ( i , j , λ , {λ}^{′} ) = {( {\sum }_{k = 1}^{K} \vert \vert {ξ}_{i j}^{( k )} {ξ}_{{λλ}^{′}}^{( k )} {\vert \vert}^{α} )}^{1 / α} ,$$
“K” denotes the number of elements of a character vector for a defined binary relation; and “ρ” is a measure of the difference in compatibility between node-label pairs.

10. The line based image matching method of claim 1, before measuring the similarity on the basis of the continuous relaxation labeling, further comprising assigning a uniform initial probability to a predetermined number of upper node-label pairs in which the sums of the highest degree of support by each adjacent label for the nodes are within the range of an upper level, the initial probability being close to the final probability.

11. The line based image matching method of claim 10, after assigning the uniform initial probability to the upper node-label pairs, further comprising defining a probability update element for the continuous relaxation labeling as:
$${q}_{i}^{( k )} ( λ ) = {\sum }_{j} {α}_{i} ( {\sum }_{λ} {r}_{i j} ( λ , {λ}^{′} ) {p}_{j}^{( k )} ( {λ}^{′} ) )$$
where pⱼ^{(k)}(λ′) denotes the node-to-label correspondence probability, and k denotes the number of iterations needed.

12. The line based image matching method of claim 11, after defining the probability update element, further comprising updating the probability on the basis of the Zucker's theory using
$${p}_{i}^{( k + 1 )} ( λ ) = {p}_{i}^{( k )} ( λ ) + {p}_{i}^{( k )} ( λ ) \frac{{q}_{i}^{( k )} ( λ ) - \overline{{q}_{i}^{( k )}}}{{q}_{i}^{( k )}}$$
where
$${q}_{i}^{( k )} = {\sum }_{j} α {\sum }_{λ} {r}_{i j}^{( k )} ( λ , {λ}^{′} ) {p}_{j}^{( k )} ( {λ}^{′} ) , \\ and$$
$$\overline{{q}_{i}^{( k )}} = {\sum }_{λ} {p}_{i}^{( k )} ( λ ) {q}_{i}^{( k )} ( λ ) .$$

13. The line based image matching method of claim 1, where measuring the similarity between the query and model images comprises:
calculating the sum of the distances between corresponding node-to-label pairs of the sets of lines for the query and each of the model images; and
determining the reciprocal of the sum of the distances as the similarity between corresponding two images.

14. The line based image matching method of claim 13, wherein the distances are measured using the Euclidean distance or the Housdorff distance.
